(19) United States
(12) Patent Application Publication
(10) Pub. No.: US 2003/0067374 A1
(43) Pub. Date: Apr. 10, 2003

(54) Transformer coil bracket

(75) Inventor: Chih-Peng Wu, Taipei (TW)

Correspondence Address: DOUGHERTY & TROXELL, SUITE 1404, 5205 LEESBURG PIKE, FALLS CHURCH, VA, 22041, US

(73) Assignee: Primax Electronics Ltd.

(21) Appl. No.: 10/166,674

(22) Filed: Jun. 12, 2002

(30) Foreign Application Priority Data
Oct. 9, 2001 (TW) 90124960

(51) Int. Cl. H01F 27/02

(52) U.S. Cl. 336/83

(57) ABSTRACT

A transformer coil bracket includes a bracket body having a horizontal iron core trough formed in the center thereof and two ends which have respectively input terminals and output terminals extending downwards. The exterior of the iron core trough is wound by a primary coil and a secondary coil which connect electrically and respectively with the input terminals and output terminals. The iron core trough is coupled with an iron core which serves as a magnetic induction medium of the transformer. There is a horizontal wall located between the iron core and the input and output terminals to increase creepage distance between the iron core and terminals for reducing transformer thickness.

### FIELD OF THE INVENTION

The present invention relates to a transformer coil bracket and particularly a coil bracket for increasing the creepage distance between the iron core and the terminals to reduce the thickness of the transformer.

### BACKGROUND OF THE INVENTION

Transformer is a commonly used element in electronic circuit systems. It provides the function of transferring power supply or voltage to meet the requirements of different electric products. Among various transformers, the high frequency transformer has the advantages of high reliability, small size and light weight, thus is widely used in alternate power supply devices or chargers. As the transformer plays an important role in electric devices, every country has safety standards for transformers to protect user safety in utilizing electricity and prevent damage of internal electronic elements. UL safety standard is the most widely recognized standard in the world, and is widely adopted by most transformer manufacturers.

Referring to FIG. 1 for a conventional transformer coil bracket 10, it consists of a body 11 made of an insulation plastic material and having a horizontal iron core trough 12 in the center, input terminals 13 extending downwards at one end, and output terminals 14 extending downwards at another end of the bracket. The exterior surface of the iron core trough 12 is wound concentrically with a primary coil 15 and a secondary coil 16 to couple respectively with the input terminals 13 and output terminals 14. The primary coil 15 and the secondary coil 16 are insulated and separated by an insulation adhesive tape 17 located therebetween to prevent short circuit from happening or causing hazards. The body 11 further is coupled with two sets of EE-shaped iron cores 18. Each E-shaped iron core 18 has a center jutting end 181 housed in the iron core trough 12 in a symmetrical manner and jutting side ends 182 located at two sides of the body 11 for forming a shell type coil iron core transformer. The iron core 18 has a greater magnetic conductivity coefficient to serve as the magnetic induction medium of the transformer for increasing efficiency and reducing magnetic flux loss.

Referring to FIGS. 2A and 2B for a conventional transformer coil bracket to couple with a circuit board, when the transformer is used on electric products (such as chargers or notebook computers), the terminals 13, 14 of the coil bracket 10 usually are directly soldered to the circuit board 20 of the electric products. UL conventions have certain specifications and dimensional limitations for various components of the transformer, such as coil length, width and height. The limitations on transformer height is a major reason why a lot of products cannot be shrunk to a smaller height. The main limitation on transformer height results from UL's rules for creepage distance. It is a distance taken from the solder point A, B of the terminals 13, 14 of the coil bracket 10 to the corresponding vertical point A′, B′ on the iron core 18 along the insulation element surface (shown by a broad black line in FIG. 2B). A greater creepage distance will result in a lower scattered inductance and reduced leakage current. However it also results in a greater transformer thickness and makes the electric products more difficult to shrink the size.

Thus to reduce transformer thickness and increase creepage distance to obtain smaller size transformers with enhanced quality has become a major research and development focus for many transformer producers these days.

### SUMMARY OF THE INVENTION

The primary object of the invention is to provide a transformer coil bracket that is capable of increasing the creepage distance and reducing transformer thickness thereby to make the transformers smaller size with improved quality.

To achieve aforesaid objects, the coil bracket of the invention mainly includes a bracket body, a primary coil, a secondary coil and an EE iron core set. The bracket body is an insulation structure having a horizontal iron core trough and two ends which have respectively input terminals and output terminals extended located thereon and extended downwards. The primary coil and secondary coil have respectively a plurality of winding coil elements and are wound around the exterior surface of the iron core trough in a concentric fashion, and are interposed and separated by an insulation plastic sheet or other insulation materials to prevent short circuit from happening. The primary coil is coupled with the input terminals, while the secondary coil is coupled with the output terminals. The EE iron core set has two center jutting ends symmetrically housed in the iron core trough and two side jutting ends located at two sides of the bracket body to form a shell type coil iron core transformer. The magnetic flux generated by the coils is restricted on the paths formed in the iron core. Thus electric power supply may enter the primary coil from the input terminals and induce magnetic induction through the primary coil and secondary coil, then generates desired output voltage on the output terminals.

In the invention, on the vertical surface located between the iron core set of the bracket body and the input and output terminals, there is at least one jutting section extending in a direction different from the side surface of the iron core set such that the jutting section can increase the creepage distance between the iron core set and the terminals. Hence for a given creepage distance, the transformer can be made thinner, or for a transformer of a given thickness, the design of a horizontal wall can increase the creepage distance to improve transformer quality.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional transformer coil bracket.

FIGS. 2A and 2B are schematic view s of a conventional transformer coil bracket coupling with a circuit board.

FIGS. 3A, 3B and 3C are schematic views of a first embodiment of a transformer coil bracket of the invention.

FIGS. 3D and 3E are schematic views of an embodiment of the invention with two jutting sections.

FIG. 4 is a schematic view of a second embodiment of a transformer coil bracket of the invention.

FIG. 5 is a schematic view of a third embodiment of a transformer coil bracket of the invention.

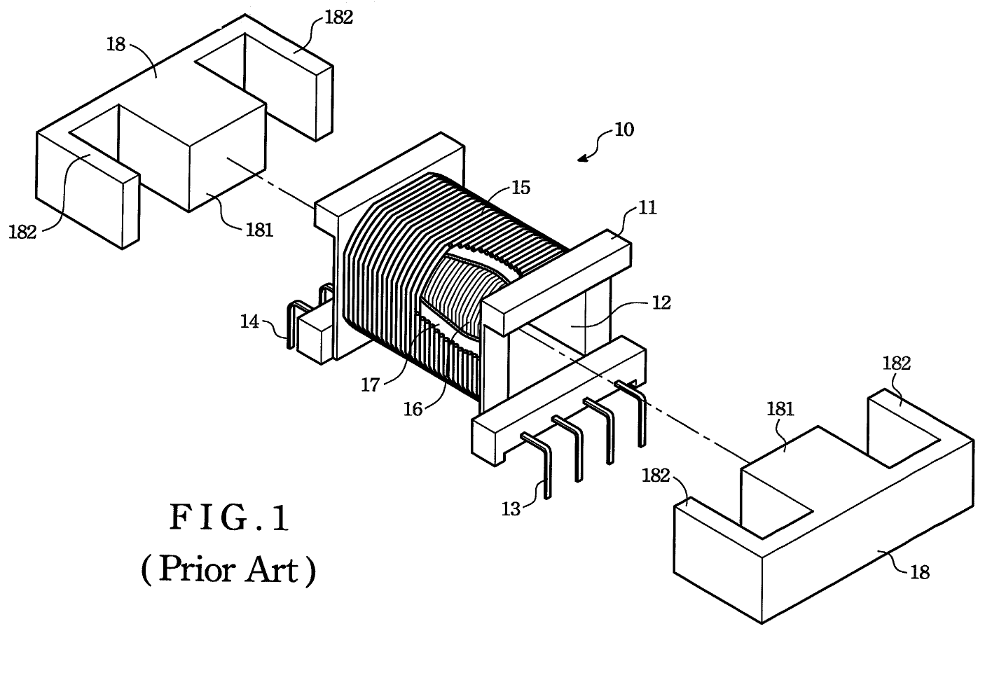

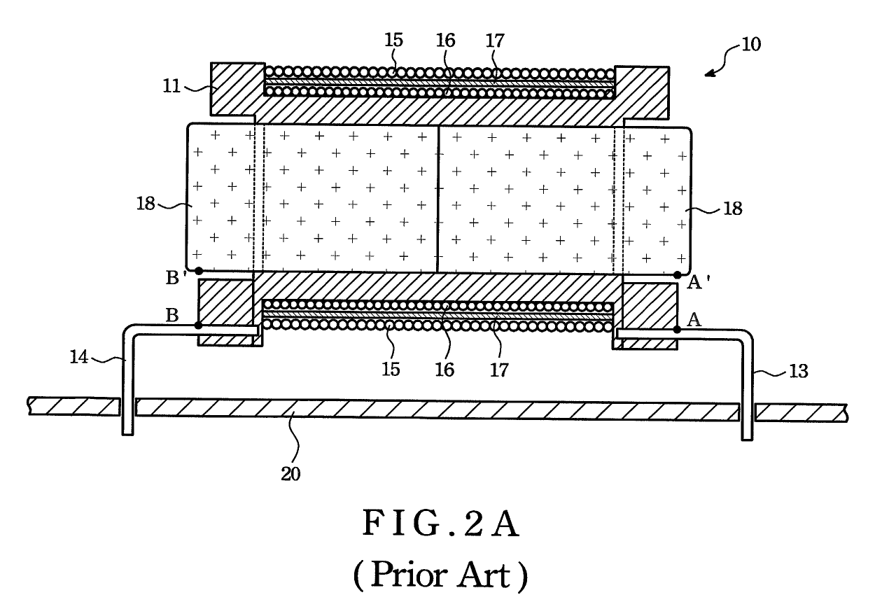

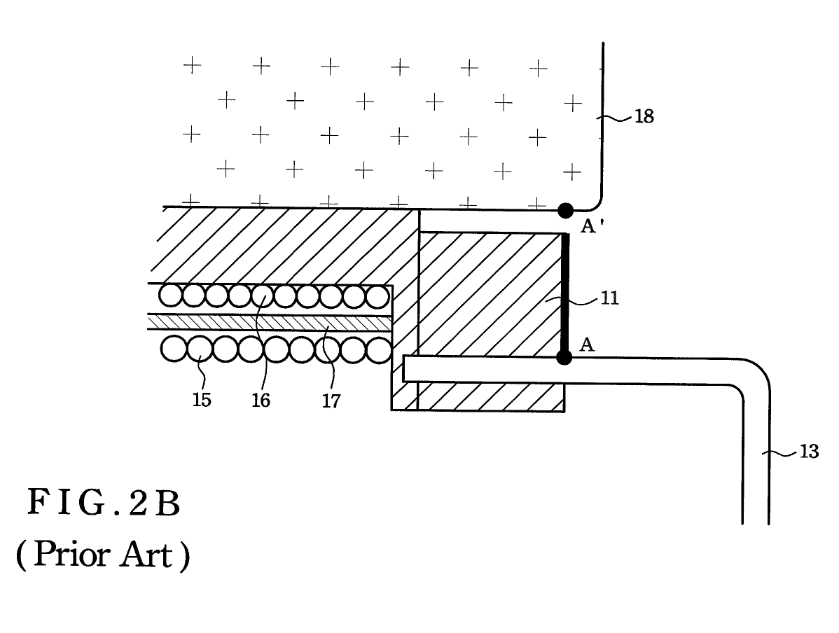

### DESCRIPTION OF THE PREFERRED EMBODIMENTS

The invention aims at providing a transformer coil bracket that has a horizontal wall to increase creepage distance for reducing transformer thickness thereby to shrink the size and improve the quality of the transformer.

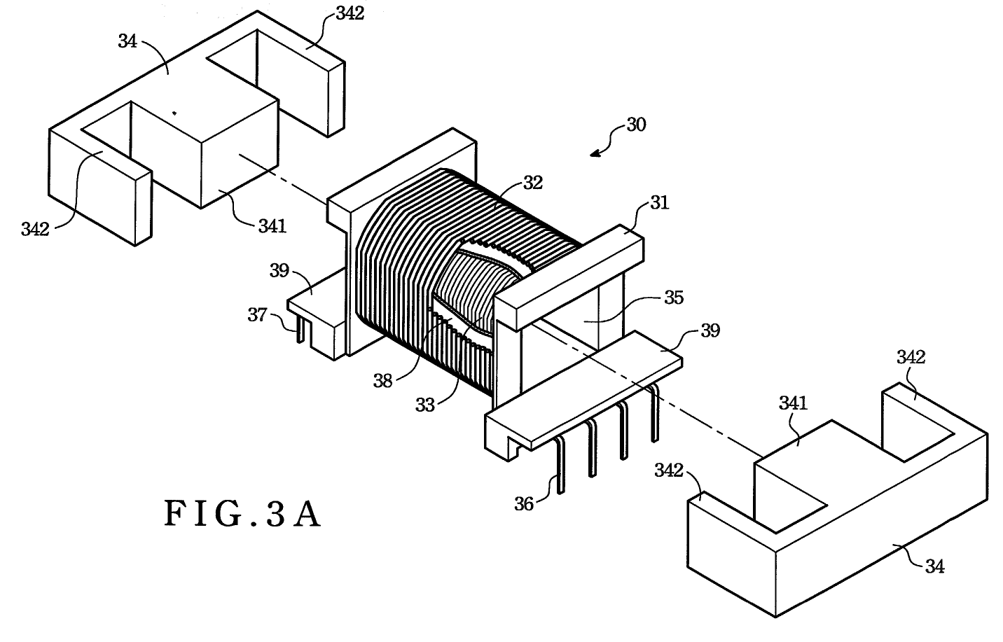

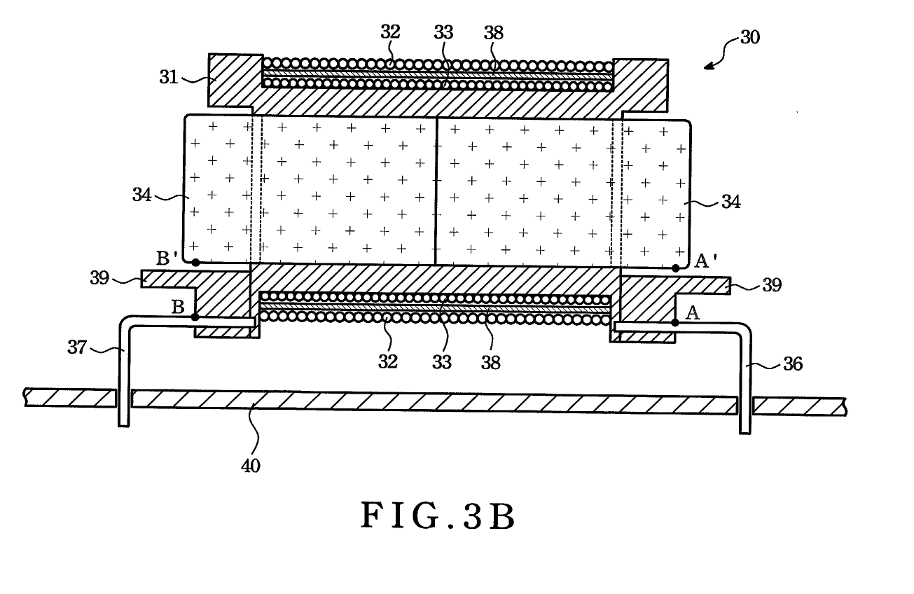

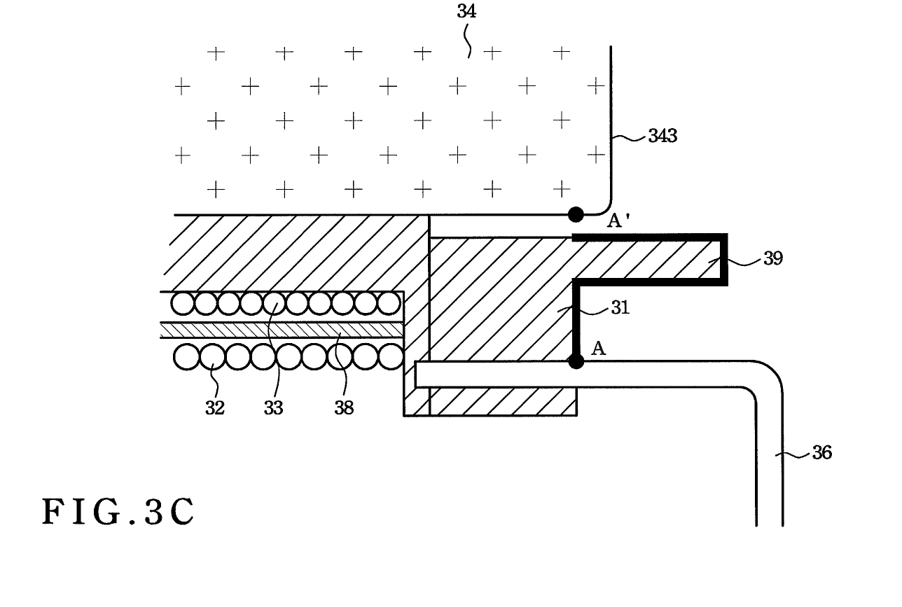

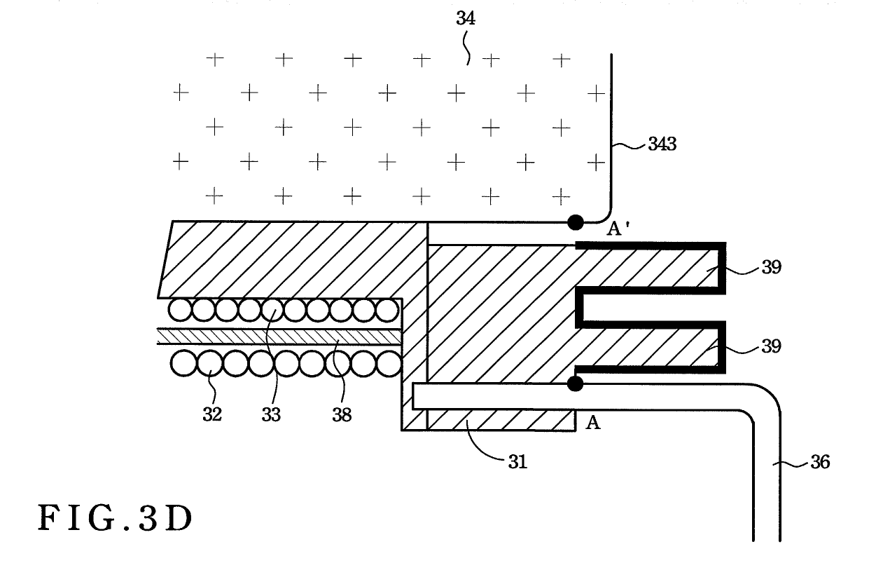

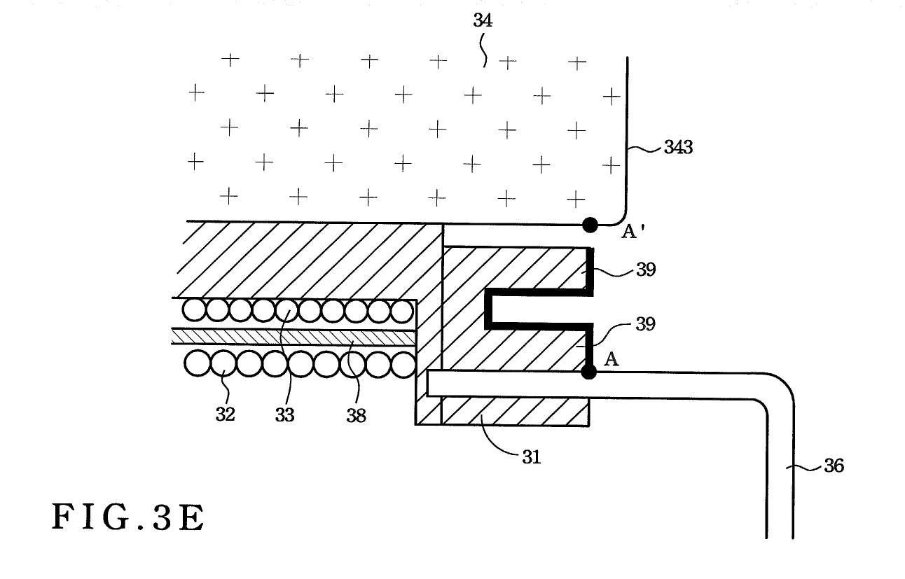

Referring to FIGS. 3A, 3B and 3C for a first embodiment of the invention, the coil bracket 30 of the invention mainly includes a bracket body 31, a primary coil 32, a secondary coil 33 and an EE iron core set 34. The bracket body 31 is made of an insulation material and has a horizontal iron core trough 35. The coils are wound around the exterior surface of the iron core trough 35. The bracket body 31 has two ends which have respectively input terminal 36 and output terminal 37 extended downwards for soldering to a circuit board 40. The secondary coil 33 is wound around the exterior surface of the iron core trough 35 and connects electrically with the output terminal 37. The primary coil 32 is wound around the iron core trough 35 outside the secondary coil 33 and connects electrically with the input terminal 36. The primary coil 32 and secondary coil 33 are enameled wires and are wound in a concentric fashion, and are interposed and separated by an insulation plastic sheet 38 or other insulation material to prevent short circuit from happening.

In this embodiment, the EE iron core set 34 consists of two E-shaped iron cores made by a powder metallurgy method. Each E-shaped iron core has a center jutting end 341 housed in the iron core trough 35 from one end and is symmetrical with another center jutting end of another iron core housed in the iron core trough 35 from another end. The iron core further has two jutting side ends 342 located at two sides of the bracket body 31 for forming a shell type coil iron core transformer. The magnetic flux generated by the coils is restricted on the paths formed in the iron core. Thus electric power supply enters the primary coil 32 from the input terminals 36 and induces magnetic induction through the primary coil 32 and secondary coil 33, then generates desired output voltage on the output terminals 37.

There is a vertical surface between the iron core set 34 of the bracket body 31 and the input and output terminals 36, 37. On the vertical surface, there is at least one jutting section extending in a direction different from the side surface 343 of the iron core set 34. The jutting section may be formed in a horizontal wall 39 extending normally from the side surface of the iron core set 34, and is preferably made of an insulation plastic material and integrally formed with the bracket body 31. Taking an example of one jutting section (horizontal wall 39), the creepage distance is the surface distance on the insulation material between the solder points A, B of the terminals 36, 36 of the coil bracket 30 and the vertical corresponding points A′, B′ on the iron core set 34 (shown by a broad black line in FIG. 3C). Comparing with conventional techniques, the presence of the horizontal wall 39 increases the creepage distance between the iron core set 34 and terminals 36, 37. Hence under a given transform design condition of same creepage distance, the transform thickness becomes smaller. On the other hand, under the condition of same thickness, the existence of the horizontal wall 39 increases the creepage distance, thus can enhance the quality and efficiency of the transformer.

Referring to FIGS. 3D and 3E for variations based on the embodiment set forth above, there are two jutting sections (horizontal walls 39) located on the vertical surfaces between the iron core set 34 and the input and output terminals 36, 37. In FIG. 3D, the two jutting sections (horizontal walls 39) extend respectively from the vertical surfaces between the iron core set 34 and the input and output terminals 36, 37. In FIG. 3E, the vertical surfaces between the iron core set 34 and the input and output terminals 36, 37 have respectively an indented trough to form an upper and a lower jutting section (horizontal walls 39). They all can attain the object of increasing the creepage distance to enhance transformer efficiency and reduce transformer thickness. It is to be noted that the jutting section is not limited to the horizontal wall 39, but may be formed in any other extending shape desired.

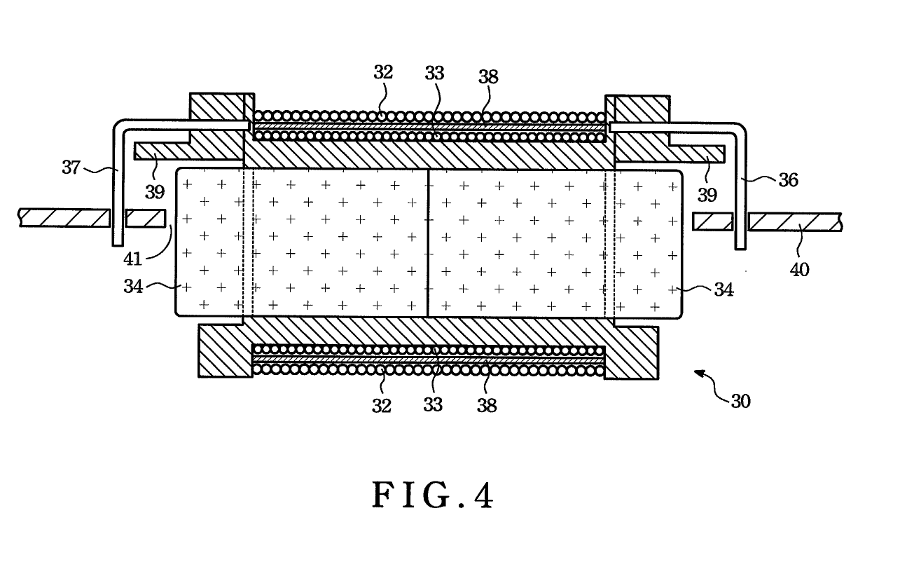

Referring to FIG. 4 for a second embodiment of the invention, the main difference of this embodiment from the first embodiment is that the input and output terminals 36a, 37a are bent upwards for 180 degrees, and the circuit board 40 has an opening 41 for wedging and coupling with the transformer in an inverse manner, and the terminals 36a, 37a may be soldered to circuit board 40. Such a construction can further reduce the extending height of the transformer over the circuit board 40 surface.

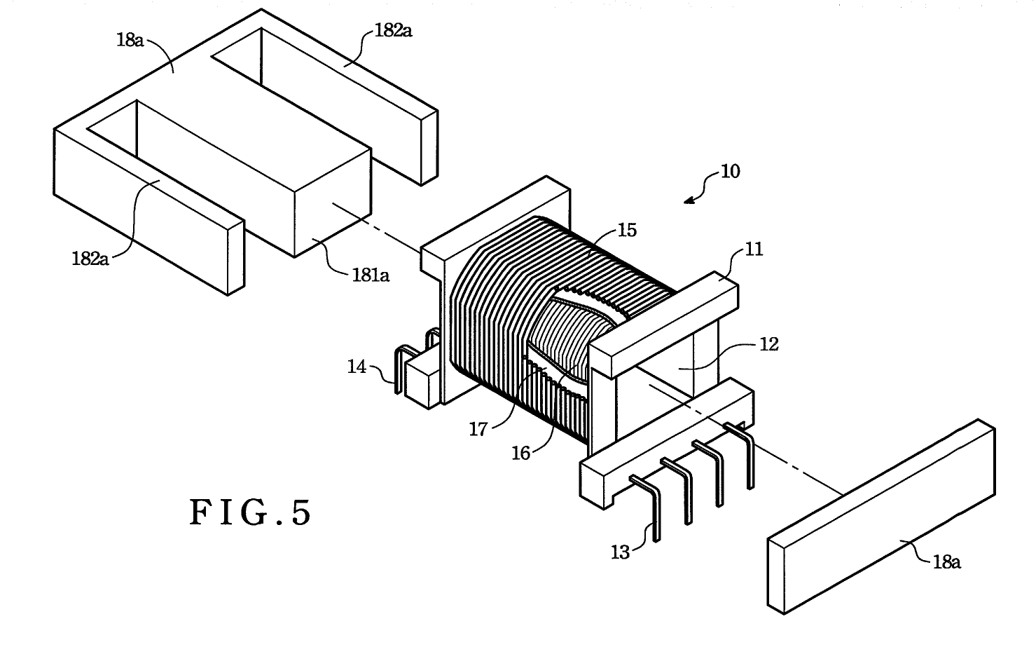

Referring to FIG. 5 for a third embodiment of the invention. In this embodiment, the iron core set 34 for the coil bracket 30 is an EI type rather than the EE type set forth above. It thus can be seen that the invention can be adapted for any shape or type of iron core to restrict the magnetic flux on the paths formed in the iron core set and to increase the transformer efficiency.

In summary, the transformer coil bracket of the invention can effectively increase the creepage distance to enhance transformer efficiency and reduce transformer thickness.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A transformer coil bracket, comprising:
a bracket body having a horizontal iron core trough formed in the center thereof and two ends which have respectively input terminals and output terminals extending downwards;
a primary coil wound around the exterior of the iron core trough of the bracket body having two ends connecting electrically with the input terminals;
a secondary coil wound around the exterior of the iron core trough of the bracket body having two ends connecting electrically with the output terminals; and
an iron core set coupled with the iron core trough of the bracket body to function as a magnetic induction medium;
wherein the iron core set and the input and output terminals form respectively a vertical surface therebetween, the vertical surface having at least one jutting section extended therefrom in a direction different from a side surface of the iron core set thereby to increase creepage distance between the iron core set and the terminals for enhancing transformer efficiency and reducing transformer thickness.

2. The transformer coil bracket of claim 1, wherein the input terminals and the output terminals are soldered to a circuit board.

3. The transformer coil bracket of claim 2, wherein the input terminals and the output terminals are bent upwards for 180 degrees for soldering to the circuit board, the circuit board having an opening to hold the transformer in an inverse manner.

4. The transformer coil bracket of claim 1, wherein the primary coil and the secondary coil are interposed and separated by an insulation layer to prevent short circuit from happening.

5. The transformer coil bracket of claim 1, wherein the primary coil and the secondary coil are wound concentrically around the iron core trough with the primary coil shrouding the secondary coil from outside.

6. The transformer coil bracket of claim 1, wherein the iron core set is an EE core.

7. The transformer coil bracket of claim 1, wherein the iron core set is an EI core.

8. The transformer coil bracket of claim 1, wherein the horizontal wall is made of an insulation plastic material.

9. The transformer coil bracket of claim 1, wherein the horizontal wall is integrally formed with the bracket body.

10. The transformer coil bracket of claim 1, wherein the primary coil and the secondary coil are made of enameled wires.

11. The transformer coil bracket of claim 1, wherein the jutting section is a horizontal wall.

12. A transformer coil bracket, comprising:
a bracket body having a horizontal iron core trough formed in the center thereof and two ends which have respectively input terminals and output terminals extending downwards;
a primary coil wound around the exterior of the iron core trough of the bracket body having two ends connecting electrically with the input terminals;
a secondary coil wound around the exterior of the iron core trough of the bracket body having two ends connecting electrically with the output terminals;
an iron core set coupled with the iron core trough of the bracket body to function as a magnetic induction medium; and
at least one jutting section located on a vertical surface between the iron core set and the input and output terminals and extended from the vertical surface in a direction different from a side surface of the iron core set thereby to increase creepage distance between the iron core set and the terminals for enhancing transformer efficiency and reducing transformer thickness.

13. The transformer coil bracket of claim 12, wherein the input terminals and the output terminals are soldered to a circuit board.

14. The transformer coil bracket of claim 13, wherein the input terminals and the output terminals are bent upwards for 180 degrees for soldering to the circuit board, and the circuit board having an opening to hold the transformer in an inverse manner.

15. The transformer coil bracket of claim 12, wherein the primary coil and the secondary coil are interposed and separated by an insulation layer to prevent short circuit from happening.

16. The transformer coil bracket of claim 12, wherein the primary coil and the secondary coil are wound concentrically around the iron core trough with the primary coil shrouding the secondary coil from outside.

17. The transformer coil bracket of claim 12, wherein the iron core set is an EE core.

18. The transformer coil bracket of claim 12, wherein the iron core set is an EI core.

19. The transformer coil bracket of claim 12, wherein the horizontal wall is made of an insulation plastic material.

20. The transformer coil bracket of claim 12, wherein the horizontal wall is integrally formed with the bracket body.

21. The transformer coil bracket of claim 12, wherein the primary coil and the secondary coil are made of enameled wires.

22. The transformer coil bracket of claim 12, wherein the jutting section is a horizontal wall.
